(19) United States
(12) Patent Application Publication
(10) Pub. No.: US 2026/0268644 A1
(43) Pub. Date: Sep. 10, 2026

(54) SYSTEM FOR ARTIFICIAL INTELLIGENCE LEARNING BASED ON ENTROPY RELATING TO SEMANTIC SEGMENTATION OF POINT CLOUD AND METHOD IMPLEMENTING THE SAME

(71) Applicants: Hyundai Motor Company, Seoul (KR); Kia Corporation, Seoul (KR)

(72) Inventors: Tae San KIM, Hwaseong-Si (KR); Sang Won HWANG, Hwaseong-Si (KR)

(21) Appl. No.: 19/326,220

(22) Filed: Sep. 11, 2025

(30) Foreign Application Priority Data
Mar. 5, 2025 (KR) 10-2025-0028506

(51) Int. Cl. G06V 10/776; B60W 50/04; B60W 60/00; G05B 13/02; G06V 10/26; G06V 10/764; G06V 10/774; G06V 20/56

(52) U.S. Cl. CPC G06V 10/776; B60W 50/045; B60W 60/001; G05B 13/027; G06V 10/26; G06V 10/764; G06V 10/774; G06V 20/56; B60W 2050/046

(57) ABSTRACT

An apparatus of a vehicle may comprise a processor and a memory storing at least one instruction that, when executed by the processor communicating with the memory, is configured to cause the apparatus to train, using a first dataset, artificial intelligence (AI) model that recognizes an object based on data input from a sensor of the vehicle, perform the recognition function on a point cloud input from the sensor, determine entropy of the AI model, determine an edge case and an edge class, generate a segmentation ground truth (GT) as a pseudo label for a second dataset, retrain the AI model, output a signal indicating recognition of at least one object, and control, based on the signal, autonomous driving of the vehicle.

### CROSS-REFERENCE TO RELATED APPLICATION

This application claims the benefit of priority to Korean Patent Application No. 10-2025-0028506, filed with the Korean Intellectual Property Office on Mar. 5, 2025, the entire contents of which are incorporated herein by reference.

### TECHNICAL FIELD

The present disclosure relates to an artificial intelligence learning system and method based on entropy for semantic segmentation of a point cloud, and more specifically, to a system and method for learning AI based on entropy to cope with limitations of a deep learning model for semantic segmentation of a point cloud.

### BACKGROUND

The matters described in this Background section are only for enhancement of understanding of the background of the disclosure, and should not be taken as acknowledgment that they correspond to prior art already known to those skilled in the art.

With the development and commercialization of autonomous vehicles, the use of various sensors and artificial intelligence (AI) technologies to support autonomous driving functions of vehicles is increasing. For example, research is ongoing into what object exists in front of a moving vehicle, what the distance is between the object and the vehicle, and what algorithm the vehicle should use to respond to specific situations to ensure safety.

Accordingly, vehicle sensor technology is becoming more advanced, and high-performance sensors such as light detection and ranging (LiDAR) that recognizes a surrounding environment using a laser beam, radio detection and ranging (RADAR) that uses radio waves, ultrasonic sensors, fisheye cameras capable of shooting 360-degree images, multifocal lenses, and a global positioning system (GPS) are being installed in a vehicle.

As above, by integrating measurement results obtained from a plurality of sensors, it has become possible to implement a super sensor vehicle. In self-driving (autonomous driving), concept of a super sensor refers to a technology that seeks to more accurately recognize the surrounding environment by combining measurements from various sensors rather than relying on individual sensors for convenience and safety of driving. With the addition of information and communications technology (ICT) and cloud technology, sensors and AI algorithms required for autonomous driving are becoming more sophisticated than ever before, not only for a single vehicle, but also for a fleet of vehicles, remotely accumulating data and training AI servers and databases to increase reliability of vehicle sensor determination.

However, despite advancements in AI and deep learning technologies, there are uncertain cases (e.g., edge cases), where semantic segmentation networks fail to make accurate predictions on point cloud data acquired from LIDAR sensors.

Recognizing errors in edge cases is considered in autonomous driving environments, highlighting the necessity of finding solutions to overcome these edge case challenges.

### SUMMARY

The present disclosure attempts to implement an entropy-based artificial intelligence (AI) learning system and method related to point cloud semantic segmentation. More specifically, the technical challenge lies in implementing a system and method for training AI based on entropy to address edge cases in deep learning models related to point cloud semantic segmentation.

Of course, the technical problems of the present disclosure are not limited to the technical problems mentioned above, and other technical problems not explicitly mentioned will be clearly understood by those skilled in the art from the detailed description of the present disclosure and the attached drawings.

According to the present disclosure, an apparatus of a vehicle, the apparatus may comprise a processor, and a memory storing at least one instruction that, when executed by the processor communicating with the memory, is configured to cause the apparatus to, train, using a first dataset, artificial intelligence (AI) model that recognizes an object based on data input from a sensor of the vehicle, wherein the AI model is trained to perform a recognition function for objects, wherein the objects are classified into multiple classes from an arbitrary point cloud based on deep learning and semantic segmentation of a sensor point cloud, perform the recognition function on a point cloud input from the sensor, based on the point cloud input, object classifications, and a prediction rate of the AI model, determine entropy of the AI model, determine, based on the determined entropy, an edge case and an edge class associated with the recognition function, generate a segmentation ground truth (GT) as a pseudo label for a second dataset, wherein the second data set may comprise point cloud data associated with at least one object belonging to the edge class, based on the second data set and the segmentation ground truth, retrain the AI model to perform the recognition function, output, based on the retrained AI model, a signal indicating recognition of at least one object, and control, based on the signal, autonomous driving of the vehicle.

The apparatus, wherein the at least one instruction, when executed by the processor communicating with the memory, is configured to cause the apparatus to execute, based on the retrained AI model to perform the recognition function, an object recognition process for a point cloud, wherein the point cloud may comprise the edge class. The apparatus, wherein the at least one instruction, when executed by the processor communicating with the memory, is configured to cause the apparatus to, based on an execution result of the object recognition process, measure a degree of performance improvement associated with the edge case and the edge class.

The apparatus, wherein the edge case refers to a maximum prediction entropy frame in which the determined entropy is a highest among a plurality of frames, and wherein the plurality of frames comprise the point cloud input from the sensor. The apparatus, wherein the edge class refers to a class of an object that has a greatest influence on causing the determined entropy to be a highest within the maximum prediction entropy frame. The apparatus, wherein the at least one instruction, when executed by the processor communicating with the memory, is configured to cause the apparatus to retrain the AI model by, retraining the AI model to recognize a misclassified object of the edge class, using a segmentation GT updated with a corrected label based on the semantic segmentation in an image area, wherein the image area may comprise the misclassified object, and wherein the corrected label is based on the measured degree of performance improvement associated with the edge case and the edge class.

The apparatus, wherein the at least one instruction, when executed by the processor communicating with the memory, is configured to cause the apparatus to measure the degree of performance improvement by measuring an improvement rate of intersection over union (IoU) or mean IoU (mIoU), wherein the IoU or the mIoU is determined from a predicted bounding box (P-Box) generated based on the AI model, a GT bounding box set for the edge class, and the retrained AI model. The apparatus, wherein the degree of performance improvement is determined in an evaluation condition in which the IoU for the edge class increases to a second threshold or higher, even though the mIoU decreases within a first threshold.

The apparatus, wherein the at least one instruction, when executed by the processor communicating with the memory, is configured to cause the apparatus to, based on an over sampling rate (OSR) yielding a degree of performance improvement greater than a preset threshold, adjust a size of the second dataset. The apparatus, wherein an OSR threshold at which the degree of performance improvement begins to decrease is determined as an OSR maximum limit value.

According to the present disclosure, a method performed by an apparatus of a vehicle, the method may comprise training, using a first dataset, artificial intelligence (AI) model that recognizes an object based on data input from a sensor of the vehicle, wherein the AI model is trained to perform a recognition function for objects, wherein the objects are classified into multiple classes from an arbitrary point cloud based on deep learning and semantic segmentation of a sensor point cloud, performing the recognition function on a point cloud input from the sensor, based on the point cloud input, object classifications, and a prediction rate of the AI model, determining entropy of the AI model, determining, based on the determined entropy, an edge case and an edge class associated with the recognition function, generating a segmentation ground truth (GT) as a pseudo label for a second dataset, wherein the second data set may comprise point cloud data associated with at least one object belonging to the edge class, based on the second data set and the segmentation ground truth, retraining the AI model to perform the recognition function, outputting, based on the retrained AI model, a signal indicating recognition of at least one object, and controlling, based on the signal, autonomous driving of the vehicle.

The method may further comprise executing, based on the retrained AI model to perform the recognition function, an object recognition process for a point cloud, wherein the point cloud may comprise the edge class. The method may further comprise based on an execution result of the object recognition process, measuring a degree of performance improvement associated with the edge case and the edge class. The method, wherein the edge case refers to a maximum prediction entropy frame in which the determined entropy is a highest among a plurality of frames, and wherein the plurality of frames comprise the point cloud input from the sensor.

The method, wherein the edge class refers to a class of an object that has a greatest influence on causing the determined entropy to be a highest within the maximum prediction entropy frame. The method, wherein the retraining of the AI model may comprise retraining the AI model to recognize a misclassified object of the edge class, using a segmentation GT updated with a corrected label based on the semantic segmentation in an image area, and wherein the image area may comprise the misclassified object, and wherein the corrected label is based on the measured degree of performance improvement associated with the edge case and the edge class.

The method, wherein the measuring of the degree of performance improvement may comprise measuring an improvement rate of intersection over union (IoU) or mean IoU (mIoU), wherein the IoU or the mIoU is determined from a predicted bounding box (P-Box) generated based on the AI model, a GT bounding box set for the edge class, and the retrained AI model.

According to the present disclosure, a vehicle may comprise a sensor, a driving control circuit configured to control autonomous driving of the vehicle, a processor, and a memory storing at least one instruction that, when executed by the processor communicating with the memory, is configured to cause the vehicle to, obtain, from the sensor, a point cloud representing a surrounding environment of the vehicle, perform, using a trained artificial intelligence (AI) model, a semantic segmentation on the point cloud to recognize at least one object and assign the at least one object to a class among a plurality of classes, based on the point cloud, the class, and a prediction rate of the AI model, determine a prediction entropy value of the AI model, identify a frame having a highest prediction entropy among a plurality of frames, wherein the plurality of frames may comprise point clouds, and wherein the frame is defined as an edge case, identify, among the plurality of classes, a class of an object contributing most to a highest entropy in the edge case, the class being defined as an edge class, generate, based on the edge class, a second dataset, wherein the second dataset may comprise a plurality of point clouds corresponding to the edge class, generate, for the second dataset, segmentation ground truth data using pseudo-labeling or manual labeling, based on the second dataset and the segmentation ground truth data, retrain the AI model, output, based on the retrained AI model, a signal indicating recognition of the object, and control, via the driving control circuit and based on the signal, autonomous driving of the vehicle.

The vehicle, wherein the at least one instruction, when executed by the processor communicating with the memory, is configured to cause the vehicle to determine a size of the second dataset based on an over sampling rate (OSR) that yields a highest improvement in recognition performance without exceeding an OSR maximum limit value that degrades accuracy of the AI model.

The vehicle, wherein the at least one instruction, when executed by the processor communicating with the memory, is configured to cause the vehicle to, identify, from the second dataset, a subset of frames having highest prediction entropy values associated with the edge class, and generate, using pseudo-labeling, segmentation ground truth data for the subset to selectively retrain the AI model for improved recognition of the edge class.

The present disclosure is inspired by the observation that edge cases may arise where the semantic segmentation network for deep learning-based point clouds struggles to make accurate predictions.

The recognition of errors in edge cases may be critical in autonomous driving environments, and accordingly, the present disclosure may introduce the parameter of entropy to improve the recognition performance of deep learning networks under such edge case conditions.

In summary, this disclosure aims to enhance the recognition performance of AI networks in edge case scenarios by setting boundary conditions and classes based on entropy, securing additional data for such cases, generating efficient ground truth (GT) using pseudo-labeling and manual labeling, and retraining the network accordingly.

Furthermore, various effects in addition to effects described above from the present disclosure by those skilled in the art are provided through the detailed description of the present disclosure and the attached drawings.

### BRIEF DESCRIPTION OF THE DRAWINGS

FIG. shows an example overall system for automatically recognizing objects and controlling a vehicle for purposes such as autonomous driving.

FIG. 2 shows an example overall algorithm for training an AI module based on entropy related to semantic segmentation of a LiDAR point cloud.

FIG. 3 shows an example chart showing IoU measurement values by object class before applying the present disclosure, to describe a learning process of an AI module.

FIG. 4A and FIG. 4B show an example of a method of determining entropy on a per-frame basis and setting an edge case and an edge class.

FIG. 5 show an example frame of a LiDAR point cloud image to describe edge cases and edge classes.

FIG. 6 shows an example chart showing how IoU measurement values by object class shown in FIG. 3 have been improved through a learning process of an AI module.

FIG. 7 shows an example chart showing a relationship between over sampling rate (OSR) and a size of a second dataset.

FIG. 8 shows an example computing system for autonomous vehicle control and object recognition computation.

### DETAILED DESCRIPTION

Hereinafter, some examples of the present disclosure will be described in detail with reference to exemplary drawings. It should be noted that in adding reference numerals to constituent elements of each drawing, the same constituent elements include the same reference numerals as possible even though they are indicated on different drawings. Furthermore, in describing examples of the present disclosure, in a case where it is determined that detailed descriptions of related well-known configurations or functions interfere with understanding of the examples of the present disclosure, the detailed descriptions thereof will be omitted.

In describing constituent elements according to various examples of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field to which an example of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification. For example, in the present disclosure, the term ‘object’ essentially holds same meaning as ‘entity,’ and the expressions ‘object’ and ‘entity’ will be interchangeably used throughout the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of retaining artificial intelligent model with pseudo-labeled edge case data for improving sensor object recognition) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of retaining artificial intelligent model with pseudo-labeled edge case data for improving sensor object recognition) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of retaining artificial intelligent model with pseudo-labeled edge case data for improving sensor object recognition) described herein.

Minimum risk maneuver (MRM) operation(s) may also be controlled, for example, based on one or more features (e.g., feature of retaining artificial intelligent model with pseudo-labeled edge case data for improving sensor object recognition) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of retaining artificial intelligent model with pseudo-labeled edge case data for improving sensor object recognition) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of retaining artificial intelligent model with pseudo-labeled edge case data for improving sensor object recognition) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., feature of retaining artificial intelligent model with pseudo-labeled edge case data for improving sensor object recognition) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

FIG. shows an example overall system for automatically recognizing objects and controlling a vehicle for purposes such as autonomous driving.

Referring to FIG. 1, a vehicle control apparatus 100 according to an example of the present disclosure may be implemented inside or outside a vehicle, and some of the components included in the vehicle control apparatus 100 may be implemented inside or outside the vehicle. In the instant case, the vehicle control apparatus 100 may be integrally formed with internal control units of the vehicle, or may be implemented as a separate device to be connected to control units of the vehicle by a separate connection means. For example, the vehicle control apparatus 100 may further include components (e.g., a GPS circuit, a vehicle communication interface, or a power management circuitry, etc.) not shown in FIG. 1.

The vehicle control apparatus 100 according to an example may include a processor 110, a LiDAR 120, and a memory 130. The processor 110, the lidar 120, or the memory 130 may be electronically and/or operably coupled with each other by an electronic component including a communication bus.

Hereinafter, hardware components being operatively coupled may include a direct connection, and/or an indirect connection established between the components, wired, and/or wireless, such that a second component is controlled by a first component among the components.

Although they are illustrated in different blocks, the examples are not limited thereto. For example, some of the hardware components in FIG. 1 may be included in a single integrated circuit including a system on a chip (SoC). A type and/or number of hardware components included in the vehicle control apparatus 100 is not limited to that shown in FIG. 1. For example, the vehicle control apparatus 100 may include some of the components illustrated in FIG. 1.

The vehicle control apparatus 100 according to an example may include hardware for processing data based on one or more instructions. For example, the hardware for processing data may include a processor 110. For example, the hardware for processing data may include an arithmetic and logic unit (ALU), a floating point unit (FPU), a field programmable gate array (FPGA), a central processing unit (CPU), and/or an application processor (AP). The processor 110 may be configured to have a single-core processor structure, or a multi-core processor structure including dual core, quad core, hexa core, or octa core (e.g., depending on the computational complexity of perception models, route planning, or control logic, etc.).

According to another example, the processor 110 may be configured to include at least one of a graphic processing unit (GPU), a neural processing unit (NPU), or any combination thereof. For example, the GPU may be referred to as a visual processing unit (VPU). For example, the NPU may be referred to as a neural network processing unit (e.g., enhanced or optimized for running convolutional neural networks, transformer models, or sensor fusion algorithms, etc.).

The vehicle control apparatus 100 according to an example may include a depth sensor for detecting external objects. For example, the depth sensor for detecting external objects may include at least one of a time of flight (ToF) sensor, a light detection and ranging (LiDAR) 120, a structured light sensor, an ultrasonic sensor, an infrared sensor, a radio detection and ranging (RADAR), an optical distance sensor, or any combination thereof (e.g., combining LiDAR and RADAR to improve robustness in low-visibility conditions, etc.). Hereinafter, for better understanding and ease of description, a description will focus on the LiDAR.

The vehicle control apparatus 100 according to an example may include a LiDAR120 that acquires a plurality of points based on a pulse laser signal. For example, the LiDAR120 may acquire data sets that identify objects surrounding the vehicle control apparatus 100 (or a vehicle including the vehicle control apparatus 100). For example, the LiDAR120 may identify at least one of a position, a moving direction, a speed, or any combination thereof of a surrounding object based on the pulse laser signal emitted from the LiDAR120 being reflected back by the surrounding object (e.g., a nearby vehicle, a pedestrian, a tree, or a building, etc.).

For example, the LiDAR120 may obtain data sets representing external objects in a space formed by an x-axis, a y-axis, and a z-axis based on the pulse laser signal reflected from the surrounding object. For example, the LiDAR120 may acquire data sets including a plurality of points in the space formed by the x-axis, the y-axis, and the z-axis based on receiving the pulse laser signal every designated period (e.g., every 100 milliseconds, every sensor frame, or at a refresh rate of 10 Hz, etc.). For example, the points may include points representing external objects within a 3D virtual coordinate system. The 3D virtual coordinate system may include at least one of a vehicle coordinate system, a LiDAR coordinate system, or any combination thereof. However, an example of the 3D virtual coordinate system is not limited to those described above (e.g., it may include a world coordinate system or a map-based coordinate system, etc.).

The memory 130 of the vehicle control apparatus 100 according to an example may include hardware component for storing data and/or instructions input to and/or output from the processor 110 of the vehicle control apparatus 100. For example, the memory 130 may include a volatile memory including a random-access memory (RAM), and/or a nonvolatile memory including a read-only memory (ROM).

For example, the volatile memory may include at least one of a dynamic RAM (DRAM), a static RAM (SRAM), a Cache RAM, a pseudo SRAM (PSRAM), or any combination thereof. For example, the nonvolatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof (e.g., depending on cost, size, write endurance, or access speed, etc.).

Within the memory 130 of the vehicle control apparatus 100, one or more instructions (or commands) indicating computations and/or actions to be performed by the processor 110 of the vehicle control apparatus 100 based on data may be stored. A set of one or more instructions may be referred to as a program, a firmware, an operating system, a process, a routine, a sub-routine, and/or an application (e.g., an object detector, a SLAM module, or a LiDAR segmentation engine, etc.).

Hereinafter, a point that an application is installed in a vehicle control apparatus 100 may indicate that one or more instructions provided in a form of an application are stored in the memory 130, and that one or more applications are stored in a format that is executable by the processor 110 of the vehicle control apparatus 100 (e.g., a file having an extension designated by an operating system of the vehicle control apparatus 100) (e.g., a binary executable file, or a compiled library, etc.).

For example, the memory 130 may include a first neural network model for detecting an object. For example, the memory 130 may include a second neural network model for outputting types of the points acquired by the lidar 120 and/or scores of the points (e.g., object class scores or distance likelihoods, etc.).

In an example, the processor 110 may be configured to obtain at least one of a first virtual box representing a target object, a first class representing a type of the target object, or any combination thereof, based on the points acquired through the LiDAR120 and the first neural network model stored in the memory 130.

For example, the processor 110 may be configured to obtain at least one of a first virtual box representing a target object, a first class representing a type of the target object, or any combination thereof, based on inputting a plurality of points into the first neural network model. For example, the first neural network model may include an object detection model (e.g., a 3D bounding box detector or a center-based detection network, etc.). For example, the target object may include an external object positioned within a designated distance from the vehicle control apparatus 100 (or a vehicle including the vehicle control apparatus 100) (e.g., within a 50-meter range in the forward direction, etc.). For example, the target object may include an object that is identified by the vehicle control apparatus 100 and is continuously tracked. For example, the type of the target object may include multiple types for classifying the target object. For example, the type of the target object may include at least one of a first type representing a ground, a second type representing a type that is different from the ground, or any combination thereof. However, the type of the target object is not limited to what was described above. For example, the type of the target object may include at least one of a third type representing a person, a fourth type representing a vehicle, or any combination thereof (e.g., a bicycle, a traffic cone, a tunnel wall, or a construction sign, etc.), but the present disclosure is not limited thereto.

In an example, the processor 110 may be configured to obtain, based on the points and the second neural network model, at least one of first partial points corresponding to at least a portion of the target object among the points, a second class identified through the first partial points and indicating the type of the target object, or any combination thereof. For example, the second neural network model may include a segmentation model (e.g., a range-view CNN, a point-based classifier, or a sparse voxel network, etc.).

For example, the second neural network model may include a neural network model for obtaining types of multiple points and scores of the points (e.g., softmax outputs, probability heatmaps, or class activation scores, etc.).

For example, the processor 110 may be configured to obtain first partial points corresponding to at least a portion of the target object among the points based on inputting the points into the second neural network model. For example, the processor 110 may be configured to identify the types of the points based on inputting the points into the second neural network model. For example, the processor 110 may be configured to obtain first partial points corresponding to at least a portion of the target object from among the points based on the type of each of the points (e.g., classifying some points as belonging to a vehicle, pedestrian, or roadside object, etc.).

In an example, the processor 110 may be configured to perform a first designated algorithm on the points. For example, the processor 110 may be configured to perform the first designated algorithm for classifying a type of each of the points for the points, for example, within the LiDAR data frame. For example, the processor 110 may be configured to classify second partial points corresponding to a designated type among the points. For example, the designated type may include a type representing the ground (e.g., pavement, crosswalks, or flat surfaces, etc.).

For example, the processor 110 may be configured to classify the second partial points corresponding to a designated type based on performing the first designated algorithm on the points and obtain (or identify) the first partial points by excluding the second partial points from among the points (e.g., separating above-ground structures from terrain, etc.).

For example, the processor 110 may be configured to obtain at least one of a partial class for obtaining a second class, a score for each of the points, or any combination thereof, based on inputting the points into the second neural network model. For example, the processor 110 may be configured to obtain a partial class and a score for each of the points based on inputting the points into the second neural network model. For example, the partial class may contain a classification of each of the points into an arbitrary type (e.g., tree, vehicle, pedestrian, or unknown, etc.).

For example, the processor 110 may be configured to fuse the partial class, the scores of each of the points, and the second partial points (e.g., for joint feature enhancement or confidence weighting, etc.). For example, the processor 110 may be configured to perform clustering based on fusing the partial class, the scores of each of the points, and the second partial points. For example, the clustering may involve grouping first partial points that correspond to at least a portion of the target object (e.g., to generate an instance-level region for bounding box generation, etc.).

For example, the processor 110 may be configured to obtain a point cloud for generating a second virtual box based on the first partial points. For example, the processor 110 may be configured to obtain the point cloud based on grouping the first partial points (e.g., using spatial proximity, density thresholding, or Density-Based Spatial Clustering of Applications with Noise (DBSCAN), etc.).

For example, the processor 110 may be configured to generate a second virtual box, different from the first virtual box and for representing the target object, based on the point cloud. For example, the second virtual box may include a box that includes at least some of the first partial points (e.g., tightly fitted to the object's spatial extent, etc.).

For example, the processor 110 may be configured to identify a heading direction indicating a traveling direction of the target object based on at least one of the first partial points, the point cloud, or any combination thereof (e.g., using temporal point shifts or bounding box orientation, etc.).

For example, the processor 110 may be configured to identify a position of a second virtual box in a virtual coordinate system based on at least one of the first partial points, the point cloud, or any combination thereof (e.g., by computing the centroid of the clustered points, using a bounding box anchor, or referencing vehicle-relative coordinates, etc.). For example, the processor 110 may be configured to identify a size of the second virtual box based on at least one of the first partial points, the point cloud, or any combination thereof (e.g., by estimating width, height, and depth based on point dispersion or statistical spread, etc.).

For example, the processor 110 may be configured to identify a second class based on at least one of the first partial points, the point cloud, or any combination thereof (e.g., classifying as car, pedestrian, traffic cone, or unknown, etc.). For example, the processor 110 may be configured to identify at least one of the heading direction indicating the traveling direction of the target object, a position of the second virtual box in the virtual coordinate system, the size of the second virtual box, the second class, or any combination thereof, based on at least one of the first partial points, the point cloud, or any combination thereof (e.g., to aid in trajectory prediction, collision risk estimation, or classification confidence, etc.).

For example, the processor 110 may be configured to identify the heading direction of the bounding box based on at least one of the first virtual box, the first class, the heading direction of the second virtual box, the position of the second virtual box, the size of the second virtual box, the second class, or any combination thereof (e.g., by tracking box orientation over time, using direction vectors, or aligning with lane markings, etc.). For example, the processor 110 may be configured to identify a position of the bounding box in the virtual coordinate system based on at least one of the first virtual box, the first class, the heading direction of the second virtual box, the position of the second virtual box, the size of the second virtual box, the second class, or any combination thereof (e.g., using Kalman filtering, relative coordinate mapping, or GPS reference data, etc.).

For example, the processor 110 may be configured to obtain a third class indicating a type of the target object corresponding to the bounding box based on at least one of the first virtual box, the first class, the heading direction of the second virtual box, the position of the second virtual box, the size of the second virtual box, the second class, or any combination thereof (e.g., refining classification using fusion from multiple frames, object hierarchy rules, or semantic context, etc.). For example, the processor 110 may be configured to obtain at least one of the heading direction of the bounding box, the position of the bounding box in the virtual coordinate system, the third class indicating the type of the target object corresponding to the bounding box, or a combination thereof, based on at least one of the first virtual box, the first class, the heading direction of the second virtual box, the position of the second virtual box, the size of the second virtual box, the second class, or a combination thereof (e.g., for generating object tracks, scene graphs, or vehicle control cues, etc.).

For example, the processor 110 may be configured to assign a first identifier to the second virtual box for tracking the second virtual box (e.g., a unique ID based on timestamp, class, or location hash, etc.). For example, the processor 110 may be configured to assign a second identifier corresponding to the first identifier to the bounding box (e.g., to maintain identity consistency between detection and tracking outputs, etc.).

For example, the processor 110 may be configured to track the bounding box using the second identifier. For example, the processor 110 may be configured to track the target object based on identifying a plurality of bounding boxes that include a bounding box to which the second identifier is assigned, in a plurality of frames (e.g., through temporal association or object re-identification, etc.). For example, the second identifier may be identifier assigned to a bounding box corresponding to the target object, so the processor 110 may be configured to track the target object by identifying the bounding boxes to which the second identifier is assigned in the frames (e.g., over multiple sensor cycles or time steps, etc.).

In an example, the processor 110 may be configured to output a bounding box corresponding to the target object based on at least one of the first virtual box, the first class, the first partial points, the second class, or any combination thereof (e.g., as a hexahedral 3D box, 2D projected box, or directional polygon, etc.). For example, the bounding box may include an example of the target object represented in the virtual coordinate system in the form of a hexahedron (e.g., defined by eight corner points in 3D space, etc.).

Hereinafter, operations performed by a CPU, a GPU, and/or a NPU included in the processor 110 will be briefly described.

In an example, the processor 110 may be configured to include at least one of a CPU, a GPU, an NPU, or any combination thereof. For example, at least one of the GPU, the NPU, or any combination thereof may obtain the first virtual box and the first class based on the first neural network model (e.g., a region proposal network, transformer-based model, or YOLO-like detector, etc.). For example, at least one of the GPU or the NPU may acquire the first virtual box and the first class. For example, at least one of the GPU, the NPU, or any combination thereof may obtain scores for each of the partial classes and the points for obtaining the second class based on the second neural network model. For example, at least one of the GPU or the NPU may obtain scores for each of the partial classes and the points for obtaining the second class based on the second neural network model (e.g., probability distributions over semantic labels, etc.). For example, the CPU may classify second partial points corresponding to a designated type among the points based on performing the first designated algorithm for classifying types of each of the points for the points (e.g., such as distinguishing ground, non-ground, or noise points, etc.).

As described above, the vehicle control apparatus 100 according to an example may be configured to include at least one processor 110. The vehicle control apparatus 100 may be configured to accurately detect a target object by detecting the target object using at least one processor 110. Additionally, by performing parallel processes, the vehicle control apparatus 100 may be configured to reduce a load on each processor (e.g., enabling real-time LiDAR segmentation and object tracking, etc.).

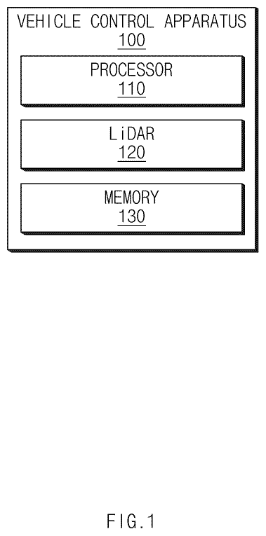

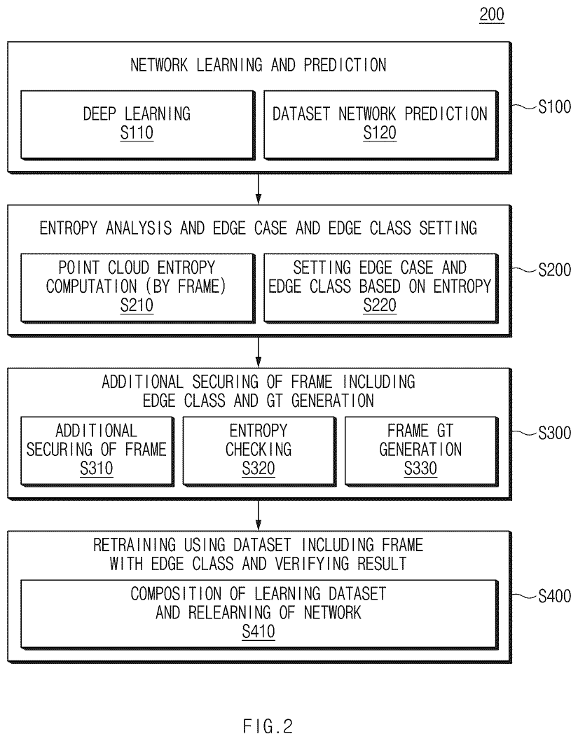

FIG. 2 shows an example overall algorithm 200 for training an AI module based on entropy related to semantic segmentation of a LiDAR point cloud. For reference, the AI module may be installed as a software module of the processor 110, and a dataset which will be described below may be input from an external dataset providing server (e.g., a cloud-based data platform or a local storage node, etc.). For example, AI module may include and execute one or more AI models (e.g., neural networks) for object recognition and segmentation in point cloud data (e.g., LiDAR point cloud data). The point cloud image recognized by the LiDAR 120 may be formed of multiple frames, with each frame containing one or more objects (e.g., vehicles, pedestrians, traffic lights, tunnels, barriers, or street furniture, etc.).

Referring to FIG. 2, in Operation S100, the AI module according to the present disclosure may train an AI neural network and execute a prediction operation to recognize an object based on the training.

The point cloud image recognized by the LiDAR 120 may be displayed in various ways, such as bird's eye view (BEV). For example, a map formed of LIDAR images may be created as if it were a bird's eye view of the city center while flying in the sky, in which case it is called a BEV image (e.g., top-down projection of 3D space onto a 2D plane for easy analysis, etc.).

The LiDAR 120 may emit a laser beam into a surrounding environment, record a time taken for the laser beam to be reflected off an external object and return, thereby generating a point for each laser signal and determining a distance to that point. By repeatedly emitting numerous laser beams, a real-time LiDAR map of the surrounding environment may be created with countless points (e.g., hundreds of thousands per scan, forming a dense 3D representation, etc.).

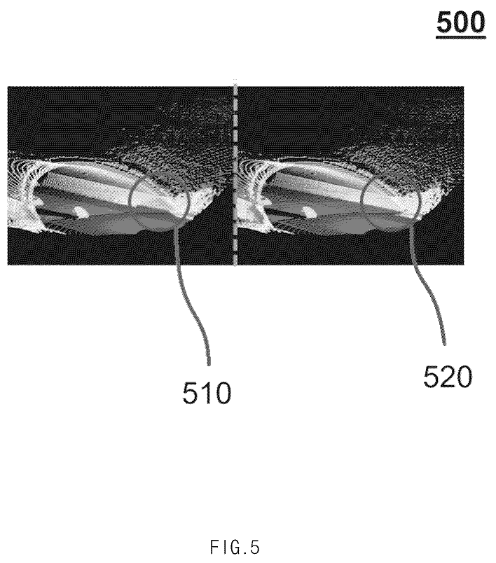

For example, lines, surfaces, structures, etc. shown in FIG. 5 described below may be in fact formed of countless points (each of which is generated by a laser beam of the LiDAR 120), and for this reason, an image like FIG. 5 is also called a LIDAR point cloud image. By combining an RGB-D (red, green, blue-depth) sensor with a LiDAR sensor, it may be possible to recreate a LiDAR point cloud image in color, and additionally, semantic segmentation may be used to assign meaning to each color, allowing the LiDAR image to be filtered accordingly (e.g., showing vehicles in red, roads in gray, pedestrians in blue, etc.).

While it may be difficult for a human to recognize objects from individual points within a LiDAR point cloud image, by aggregating multiple points, such as in FIG. 5, it may become possible to roughly estimate appearance of the surrounding environment of the vehicle currently in an autonomous driving mode. Furthermore, it may be possible to recognize a vehicle, a bus, a pedestrian, a street tree, a tunnel, etc. within the LiDAR point cloud image, and in AI image recognition technology, these are referred to as objects, and each object may be classified into a specific group, known as a class, such as a vehicle class, a bus class, a tunnel class, a pedestrian class, and so on. Of course, class classification may not be absolute, and a class may be added or removed to suit an autonomous driving scenario where the present disclosure is applied, and furthermore, a tree-class structure may be implemented, allowing multiple subclasses to exist within a certain class (e.g., a vehicle class may include car, truck, van, or emergency vehicle subclasses, etc.).

Distinguishing which object in the LiDAR point cloud image belongs to the vehicle class or the bus class may require assistance of a deep AI neural network. To detect and identify objects within the LiDAR point cloud image using the AI neural network, AI training may have to first be conducted to identify a class of each object. The present disclosure relates to AI learning through AI training. For example, the dataset called PANDASET™ may include over 48,000 camera images (mostly taken in the Silicon Valley area of the United States) and more than 16,000 LiDAR scan images, which are annotated with a total of 28 classes, including pedestrians, passenger vehicles, bicycles, construction site signs, and traffic signs (e.g., stop signs, yield signs, or speed limit indicators, etc.).

Furthermore, an LiDAR point cloud image 210 may be visualized according to a user-selected option using a point cloud processing tool such as Open3D™. The LiDAR 120 may be capable of distance detection, so a 3D LIDAR image may be rendered more realistically during visual processing with a tool like Open3D™, and for instance, an object at a greater distance may be displayed in dark blue, while a closer object may be shown in light blue (e.g., for enhanced depth perception and visualization clarity, etc.).

Furthermore, the original LiDAR point cloud image 210 may be pre-processed using a technique such as voxel down-sampling. Herein, a voxel (volumetric pixel) refers to a cube-shaped 3D pixel, and the voxel down-sampling may be a technique used to reduce a number of points in the LiDAR point cloud 210 while maintaining structures of various objects included therein, but reducing or minimizing an excessive computation requirement (e.g., AI computational requirement to enable faster training or inference, or to match GPU memory constraints, etc.).

The LiDAR 120 may emit m laser beams n times during a single scan cycle, and scan values of the laser beams that collide with and return from external objects form an (m×n) matrix, which is referred to as a range image. Each point in the LiDAR point cloud image 210 may include depth (i.e., range) information, as well as additional details such as intensity, azimuth, inclination, and other additional information of returned laser pulse (e.g., pulse width, timestamp, or number of returns, etc.). Range images may be used for AI training with large datasets, such as Waymo™ Open Dataset (WOD). Such datasets may serve as “primary dataset” for training and teaching object recognition functionality of the AI module in the present disclosure.

Range view refers to a technique that converts 3D point clouds into 2D or 2.5D scenes, allowing LiDAR 3D maps to be represented in a way that is more intuitively understandable to humans, resembling an analog drawing rather than a collection of countless points. In a range view image, a 3D LiDAR point cloud image may have 2D coordinates, but a 3D laser-related information (angle, inclination, intensity, etc.) recorded in response to obtaining the range image may not be discarded (e.g., enabling the network to retain geometric fidelity despite dimensionality reduction, etc.). A 3D LIDAR image's (x, y, z) coordinates may be transformed into a 2D range view image by applying a width variable to the (x, y) coordinates to obtain the coordinates of one axis in two dimensions and applying a height variable and range image information indicating a range (depth) to the (z) coordinate to obtain the coordinates of another axis in two dimensions.

A convolutional neural network (CNN) is an AI training module frequently used to determine features (or feature points) from image data. For this purpose, as mentioned above, there are commercially available datasets including tens of thousands of images, and CNNs currently exist in versions that can process images from one-dimensional to three-dimensional (e.g., 1D signal processing, 2D camera images, or 3D volumetric data from LiDAR, etc.). For example, a result of a range view image processing tool is trained by a CNN neural network to perform a function of helping AI accurately recognize objects in an image. For example, this process may correspond to Operation S110 for performing deep learning and Operation S120 for executing AI prediction.

In Operation S100, a semantic segmentation technique is applied. Herein, segmentation processing refers to, e.g., tagging (labeling) a specific part of a road (e.g., a traffic light) in red, and the rest (asphalt road) in blue. Semantic segmentation indicates a task of assigning a unique class label to each point in a point cloud generated by the LiDAR 120. Semantic segmentation in LiDAR image processing is a technique used to determine and utilize meaningful information from LiDAR data for object recognition or scene reconstruction, which are essential for implementing autonomous driving, and various semantic segmentation AI models already exist, such as a projection-based method, a point-based method, and a sparse convolution-based method (e.g., RangeNet++, PointNet++, or MinkowskiNet, etc.). For example, an AI prediction result from Operation S120, based on semantic segmentation, may be a computational outcome performed by the processor 110 using a NVIDIA DRIVE™ AGX system (e.g., executing inference in real-time on embedded hardware, etc.).

To further elaborate on Operation S100, an AI machine may recognize an object around an autonomous vehicle by conducting AI training using segmentation GT (ground truth bounding box). For example, the AI module may retrieve labels to recognize objects and group various objects (e.g., assigning cars, trucks, and buses to a vehicle group, or signs and lights to a traffic infrastructure group, etc.). Of course, an interval of 3D data points used to output segmentation GT may also be set, and one segmentation GT may be set to include about 50 to 1000 LiDAR cloud points.

For reference, in machine learning, GT (ground truth) is a term used to indicate an original or actual value of data that AI is trying to learn. Typically, a bounding box with a box-shaped boundary may be considered a type of image annotation applied to a LiDAR point cloud image (e.g., surrounding a pedestrian, traffic cone, or parked vehicle, etc.).

Of course, the GT annotation may not exist in the original data captured by sensors such as the LiDAR 120 while the vehicle is driving. The processor 110 may have to recognize objects belonging to various classes, such as a road sign, a crosswalk, a pedestrian, another vehicle, a center lane, a tunnel, or a barrier, etc., as objects, and GT annotation may serve as a means to measure object recognition errors by comparing object determination results recognized by the AI algorithm of the processor 110 with actual outcomes, and they are sometimes used to evaluate AI performance. The segmentation GT, which is applied to an original image in the form of annotation, may be set manually by a user, but there may also be a commercially available GT computation tool, such as grid-striding (e.g., automated bounding box generation using a fixed grid over the LiDAR image, etc.).

In a case where the AI object recognition module of the AI module is driven according to Operation S120, predicted bounding boxes may also be observed. A result recognized by the processor 110 as an object of a specific class from original image data obtained from the LiDAR sensor 120, etc., may appear in a form of another bounding box similar to the segmentation GT. Unlike the segmentation GT, the predicted bounding boxes may be computational results of autonomous driving AI. The predicted bounding box may match the segmentation GT, but it may not match the segmentation GT or may not overlap it at all. To distinguish it from the segmentation GT, the predicted bounding boxes may often be output as boxes of a different color from that of the segmentation GT (e.g., yellow for prediction, blue for ground truth, etc.).

For reference, the predicted bounding boxes alone may not definitively determine that an object of a specific class actually exists at a certain position, so the predicted bounding boxes may be usually called P-Boxes (probability boxes) or predicted bounding boxes.

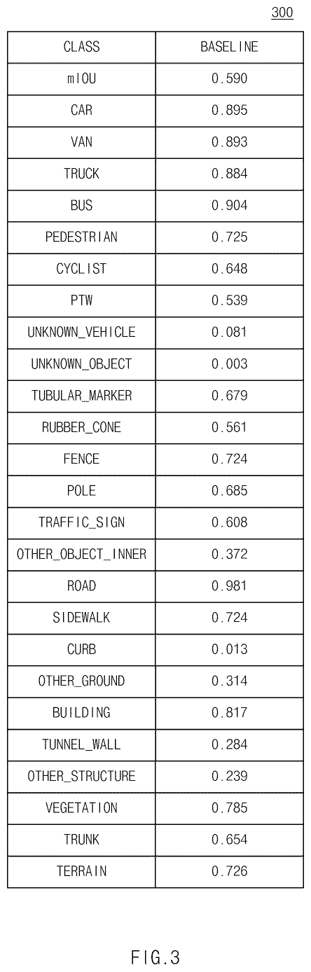

FIG. 3 illustrates an example of AI recognition performance for 25 object classes, such as cars, vans, trucks, and buses, according to step S120 (prior to applying the present disclosure; for convenience, an expression “Baseline” may be used for data prior to applying the present disclosure). For example, FIG. 3 shows an example chart 300 (prior to applying the present disclosure) showing IoU measurement values by object class before applying the present disclosure, to describe a learning process of an AI module.

Although P-Box and segmentation GT were described earlier, generating a P-Box that perfectly matches the segmentation GT through AI computation may not be an easy task. To evaluate AI prediction performance, a metric known as intersection over union (IOU) may be used, which represents an area ratio of an overlapping region between the P-Box and the segmentation GT to a total area of the P-Box and the segmentation GT (e.g., if P-Box and GT both cover 100 square pixels with 60 pixels overlapping, IoU=0.6, etc.), and an average of multiple IoU values obtained from repeated AI predictions is referred to as mIoU (Mean IoU). An IoU value of 0.5 or higher may generally indicate that object recognition performance of the AI module is satisfactory, and in FIG. 3, for instance, the AI recognition performance for an object like a road (mIoU 0.981) and a bus (mIoU 0.904) is confirmed to be outstanding, but, the mIoU for an object such as a tunnel wall is 0.284, showing significantly lower recognition performance. In other words, according to the chart 300, in a case where a tunnel is present in a LIDAR image, an area ratio at which the AI accurately recognizes the tunnel wall is around 20 to 30% (prior to applying the present disclosure).

Referring again to FIG. 2, following Operation S100, in Operation S200, entropy may be analyzed according to an example of the present disclosure, and an edge case and an edge class may be established.

Specifically, in Operation S210, a point cloud entropy value may be determined and organized on a LiDAR image on a frame-by-frame basis, using AI prediction results (i.e., P-Boxes) as illustrated in FIG. 2. In Operation S220, the edge case and the edge class may be set based on the entropy determined in Operation S210.

Issues such as class imbalance and insufficient training datasets may arise during the training process of deep learning-based point cloud semantic segmentation networks, due to these issues, there may be objects that the AI fails to properly recognize during its learning process, and in the present disclosure, such cases are referred to as “edge cases” in AI prediction. AI prediction failure in the edge case may be fatal in an autonomous driving situation, so the present disclosure is a technology developed to cope with this issue. In particular, the present disclosure determines a parameter called “entropy” according to the following Equation 1 in Operation S200 to cope with the edge case.

$$Entropy = - {\sum }_{y ∈ Y} \hat{P} ( y \vert x ) log ( \hat{P} ( y \vert x ) ) \qquad ( Equation l )$$

Herein, x refers to point cloud data input from LiDAR 120, y refers to a class (e.g., a bus, a tunnel wall, a signboard, etc.), and Prefers the prediction rate. As may be seen in equation 1, as entropy is high, the prediction rate P may approach 0.5, and the prediction rate of 0.5 may indicate that the AI module lacks confidence in its object recognition predictions, signifying uncertainty. For example, if the AI model outputs a 0.5 probability that a point belongs to either a pedestrian or a traffic light, it is effectively guessing. One important thing in AI prediction is to accept the reality that this world is full of uncertainty and that it is difficult to make predictions with 100% certainty. However, AI prediction always contains errors, and thus the resulting safety issues and other risks may be too great for autonomous driving. Therefore, it may desirable to maintain an indicator of confidence in AI prediction at an appropriate level, even if it is not too unrealistic (e.g., probabilities closer to 0.8 or higher are preferred for safe driving decisions).

In a case of the present disclosure, the semantic segmentation technique has already been applied in Operation S100, and thus in Operation S210, the entropy for the AI prediction rate may be measured for each point. This enables the AI module to analyze and identify which object or region in the LiDAR image causes prediction uncertainty.

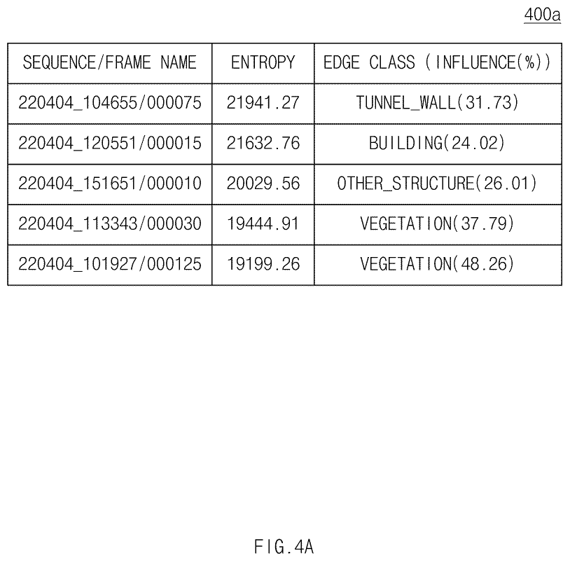

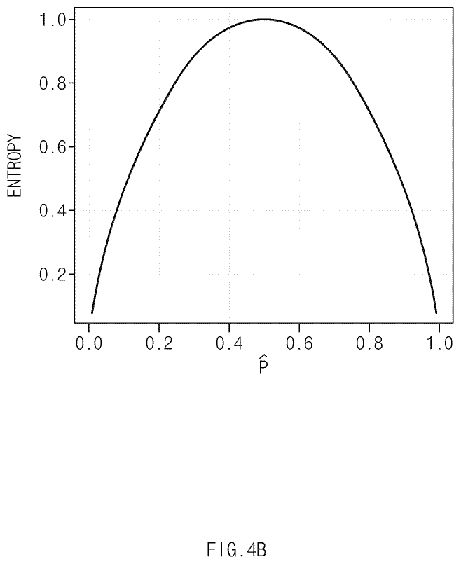

As mentioned earlier in Operation S210, point cloud entropy may be determined and organized on a frame-by-frame basis from the AI prediction results (i.e., P-Boxes), and FIG. 4A and FIG. 4B provide examples illustrating these computations and their arrangement. For example, FIG. 4A and FIG. 4B show an example of a method of determining entropy on a per-frame basis and setting an edge case and an edge class.

First, referring to FIG. 4A, data sequence input from the LiDAR 120 may be formed of multiple image frames, and each frame may be assigned a specific frame number or ID (Identification) for entropy analysis according to the present disclosure, as shown in FIG. 4A.

In the example of FIG. 4A, a frame with an ID ‘220404_104655/000075’ shows highest entropy at 21941.27, and it may be confirmed that the object that most significantly contributed to an increase in entropy of this frame is a tunnel wall, which previously had a low AI recognition rate (adversely affecting the entropy by 31.73%). For example, the tunnel wall was misclassified or uncertainly predicted in a significant number of LiDAR points within that frame.

For example, the frame “220404_104655/000075” is the “edge case” defined in the present disclosure. The edge case indicates a frame with a highest sum of entropy in each LiDAR image frame (e.g., due to multiple uncertain or misclassified objects such as tunnel walls or construction signs).

In the chart (400a) of FIG. 4A, the edge class indicates an object of the tunnel wall class. For example, in the present disclosure, the “edge class” indicates a class that has a greatest influence (e.g., measurable in percentage such as 30%, 40%, or 50%, etc.) on an increase in entropy (i.e., reducing a confidence level of AI prediction) within the determined edge case frame as described above.

As can be seen in graph 400b of FIG. 4B, according to Equation 1, the entropy is highest, meaning that AI prediction is most difficult, in a case where a P value is at a level of 0.5. This may also be confirmed in FIG. 5.

For example, FIG. 5 show an example frame 500 of a LiDAR point cloud image to describe an edge case and an edge class.

FIG. 5 illustrates a tunnel wall 510 in question within an edge case frame showing exemplary values of FIG. 3, FIG. 4A, and FIG. 4B and a preferred measurement shape 520 of the tunnel wall 510. For example, according to FIG. 5, an AI module prior to applying the present disclosure may not be properly recognizing the tunnel wall 510 that protrudes sharply forward (e.g., due to occlusion, angular distortion, or limited prior samples).

Referring again to FIG. 2, the AI module according to the present disclosure may further secure a training frame that includes the edge class in Operation S300 (which becomes a second dataset according to the present disclosure), and then generates segmentation GT for the training frame.

More specifically, Operation S310 may additionally secure a frame that includes the edge class.

An object such as a tunnel wall in FIG. 5 may correspond to an edge class that the AI module has either not yet learned or has not sufficiently learned in this example (e.g., due to low frequency, unclear contours, or insufficient ground truth). Accordingly, to improve AI object recognition performance, a frame that includes the edge class may be required.

For example, assuming the PANDASET mentioned earlier is a first dataset, images or videos that include the tunnel wall, which may cause an AI recognition error as shown in FIG. 5, may be added to the first dataset and managed as a second dataset. For example, in a case where an appropriate dataset for training image recognition of a tunnel wall is not prepared in advance, it may be necessary to prepare LiDAR point cloud images of various tunnel walls from different angles (e.g., side view, rear view, and diagonal view), and this preparation process may correspond to Operation S310.

In Operation S320, AI network prediction (i.e., P-Box generation for the second dataset) may be performed using the data secured in Operation S310, and entropy may be determined again by applying Equation 1. This determination may be made on a frame or sequence basis, and for example, in a case where the first dataset included 10,000 frames, the second dataset may include (10,000+N) frames, with N frames added that include edge class objects (e.g., 500 frames of tunnel walls or overpasses). However, as will be described later, simply increasing a size of the second dataset may not necessarily improve AI performance.

In Operation S330, based on the AI network prediction result (i.e., P-Box generated in Operation S320), segmentation GT annotation may be created for frames that include edge classes by accurately labeling a problematic tunnel wall using GT generation tools or preferably through manual labeling.

For example, in Operation S330, segmentation GT is generated for top n frames that have high entropy in AI predictions and include edge classes as a result of executing Operation S320, using a pseudo-labeling method.

Pseudo Labeling may be used to make predictions on data that has not been tagged with semantic segmentation using a model that was initially trained through AI supervised learning. This is called pseudo-labeling, as it involves tagging (i.e., labeling) using performed prediction results. Accordingly, to perform pseudo-labeling in Operation S330, a trained model and untagged data (e.g., tunnel wall, road curves, or low-visibility areas, etc.) may be required. After performing pseudo-labeling on the untagged data, secondary training may be conducted using this expanded large dataset (i.e., the second dataset).

For reference, in Operation S330, labeling may be performed manually or using segmentation-dedicated tools for misclassified edge class areas (e.g., the area 510 in FIG. 5) resulting from Operation S320. In other words, the present disclosure may significantly reduce AI computation required for GT generation by using pseudo-labels and manually labeling the edge class areas (i.e., reference numeral 510 in FIG. 5) (e.g., a misclassified tunnel wall region) in Operation S330, rather than generating segmentation GT for the entire frame and labeling each object individually.

In Operation S400, the AI module may be retrained using the training dataset that includes frames with edge classes (i.e., the second dataset), and the results may be verified.

Specifically, in Operation S410, multiple frames that include the n labeled edge classes from Operation S300 may be added to an existing training dataset (i.e., the first dataset) to create the second dataset, and the segmentation model may be retrained. After training, performance of the model applied with the present disclosure may be qualitatively or quantitatively compared and evaluated against the ‘Baseline’ using an existing validation dataset. For reference, unlabeled frames that include edge classes may be used as a dataset for performance analysis by comparing the ‘Baseline’ and the results applied with the present disclosure (e.g., comparison of P-Box overlaps with segmentation GT in tunnel scenarios).

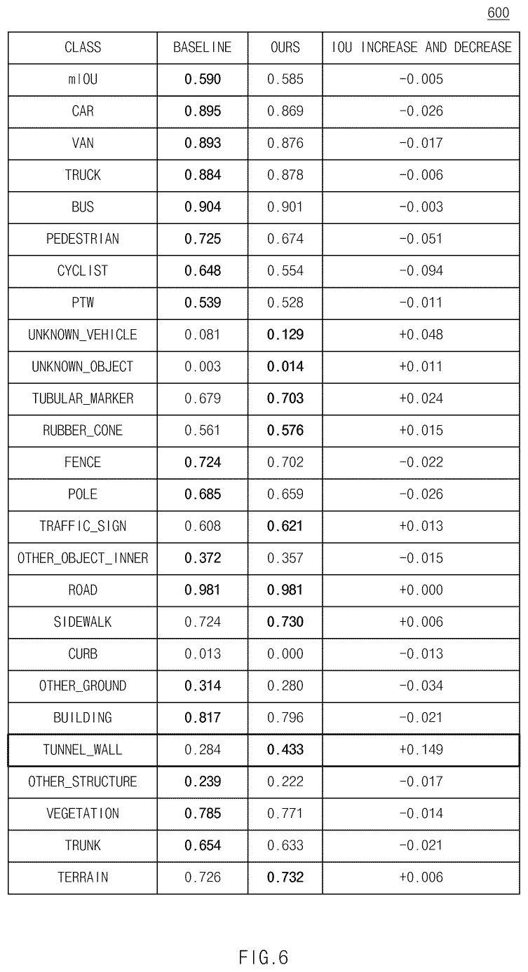

For example, FIG. 6 shows a comparison chart 600 of network training results for an edge class frames that include various tunnel wall objects. For example, FIG. 6 illustrates the example chart 600 showing how IoU measurement values (particularly, mIoU) by object class shown in FIG. 3 have been improved through a learning process of an AI module.

A most notable part of the chart 600 in FIG. 6 is that the mIoU for the tunnel wall object has been significantly improved from 0.284 to 0.433. Furthermore, in a case of the AI module learned according to the present disclosure, a number of misclassified classes (e.g., building, other structure, etc.) is also significantly reduced, and a number of correctly classified classes (e.g., particularly, tunnel wall) is significantly increased.

Of course, although the overall mIoU decreased by 0.005 compared to the ‘Baseline’ in FIG. 6, considering improvement in prediction performance for classes with previously very poor AI prediction accuracy (e.g., less than 0.3 IoU before improvement), the 0.005 mIoU reduction may be regarded as an acceptable threshold of decrease in the present disclosure.

In the analysis of Operation S400, it may be interpreted that a smaller entropy value indicates lower uncertainty in an output result of the AI network. According to the present disclosure, the AI network that has learned (i.e., re-learned) frames including edge classes has lower entropy compared to the “Baseline” (e.g., entropy drop from 21941.27 to under 17000). Of course, the output result of the AI network may be further improved through additional learning (i.e., repeated retraining) on the edge class.

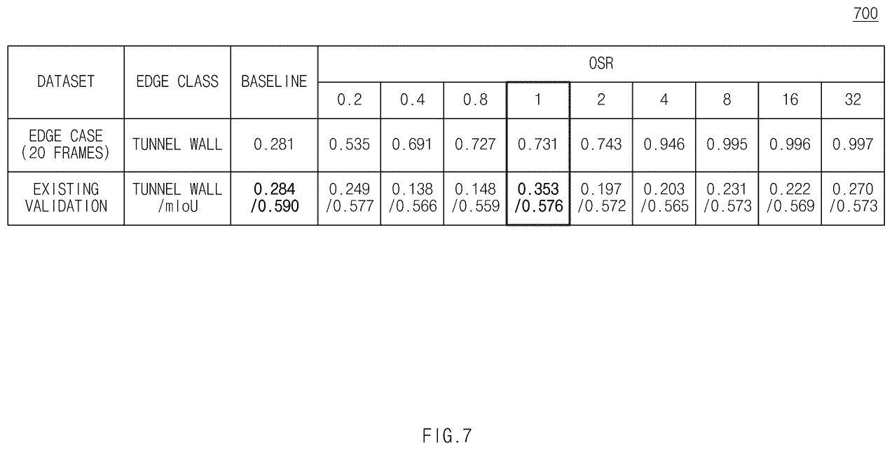

For reference, in the present disclosure, a parameter called an over sampling rate (OSR) may be used in Operation S400, for which see FIG. 7. For example, FIG. 7 shows an example chart 700 showing a relationship between the OSR and a size of a second dataset.

As shown in the chart 700, a total size (total amount of data) of the second dataset may change as the OSR is adjusted to 0.8, 1, 2, 4, etc., and for example, in FIG. 7, in a case where the OSR is 2.0, it indicates that the additional 20 frames used for learning other objects are doubled in response to the OSR of 2.0, and a total of 40 frames are used as learning data for the second dataset (e.g., 2× duplication of labeled edge class samples).

As illustrated in FIG. 7, it may be seen that the overall IoU tends to increase as a number of additional frames grows (i.e., as OSR increases). However, the OSR with best IoU performance may be 1.0. Rather, in a case where the OSR exceeds 4.0, it may lead to overfitting to frames including edge classes, resulting in degradation of performance on an existing validation dataset, as observed (e.g., IoU decline in previously well-classified road or pedestrian objects).

In other words, the present disclosure proposes that there is an optimal size for the second dataset capable of most significantly enhancing AI performance, emphasizing that merely increasing the size of the second dataset indiscriminately does not necessarily lead to better results (e.g., excessive frames of tunnel walls may lead to overfitting instead of improvement).

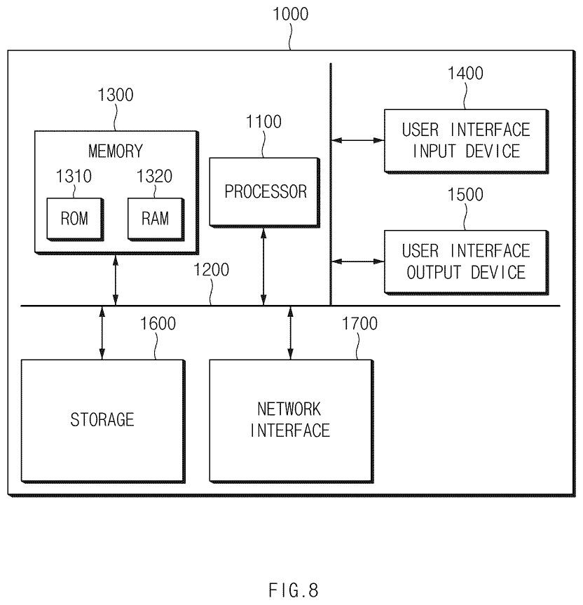

FIG. 8 shows an example computing system 1000 for autonomous vehicle control and object recognition computation.

Referring to FIG. 8, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600 (e.g., for path planning, object recognition, or entropy calculation). The memory 1300 and the storage 1600 may include various types of volatile or nonvolatile storage media. For example, the memory 1300 may include a read only memory (ROM) and a random access memory (RAM) (e.g., DRAM or SRAM).

Accordingly, steps of a method or algorithm described in connection with the examples included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM (e.g., SSD, USB drive, or optical media).

An exemplary storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal (e.g., an onboard vehicle controller or mobile computing platform). Alternatively, the processor and the storage medium may reside as separate components within the user terminal.

In order to solve all or at least part of the above-described technical problems, the present disclosure may be implemented in various examples as follows.

For example, a first example of the present disclosure relates to a learning system of an AI module based on entropy related to semantic segmentation of a LiDAR point cloud. The system of the present disclosure may include a processor configured to include an AI module that recognizes an object based on data input from a LiDAR, and a memory configured to store the input data in conjunction with the processor. Particularly, the AI module may perform operations including a first operation of learning a recognition function for objects classified into multiple classes from an arbitrary point cloud based on deep learning and the semantic segmentation using a first dataset, a second operation of actually applying the object recognition function to a point cloud input from the LiDAR, and determining entropy based on three parameters: the input point cloud, the class classifications, and a prediction rate of the AI module, a third operation of setting an edge case and an edge class of the recognition function based on the calculated entropy, and a fourth operation of generating a segmentation GT as a pseudo label for a second dataset including an object related to the edge class and then relearning a recognition function of the object.

In a case of an entropy-based AI learning system related to semantic segmentation according to a second example of the present disclosure, they may further include a fifth operation of executing an object recognition process for a point cloud including the edge class input from the LiDAR based on the relearned recognition function.

In a case of an entropy-based AI learning system related to semantic segmentation according to a third example of the present disclosure, they may further include a sixth operation of measuring a degree of performance improvement corresponding to the edge case and the edge class based on an execution result of the fifth operation.

In a case of an entropy-based AI learning system related to semantic segmentation according to a fourth example of the present disclosure, the edge case may refer to a maximum entropy frame in which the determined entropy is the highest among a plurality of frames including the point cloud input from the LiDAR.

In a case of an entropy-based AI learning system related to semantic segmentation according to a fifth example of the present disclosure, the edge class may refer to a class of an object that has greatest influence on causing the entropy to appear the highest within the maximum entropy frame.

In a case of an entropy-based AI learning system related to semantic segmentation according to a sixth example of the present disclosure, the fourth operation may include re-learning the recognition function of a misclassified edge class object based on a segmentation GT updated with a corrected label based on the semantic segmentation in an image area including the object as a result of the measurement of the sixth operation.

In a case of an entropy-based AI learning system related to semantic segmentation according to a seventh example of the present disclosure, the sixth operation may involve measuring a degree of performance improvement based on an improvement rate of intersection over union (IoU) or mIoU (Mean IoU), determined from a P-Box generated by the AI module, according to a ground truth (GT) bounding box set for the edge class and the relearned object recognition function.

In a case of an entropy-based AI learning system related to semantic segmentation according to an eighth example of the present disclosure, an evaluation section in which the performance improvement is achieved may be measured in a case where the IoU for the edge class increases to a second threshold or more, even though the mIoU decreases within a first threshold.

In a case of an entropy-based AI learning system related to semantic segmentation according to a ninth example of the present disclosure, a size of the second dataset may be determined by an over sampling rate (OSR) with a best degree of performance improvement.

In a case of an entropy-based AI learning system related to semantic segmentation according to a tenth example of the present disclosure, a reference value at which the OSR enters a section where the performance improvement is evaluated not to have been achieved as a result of the measurement of the sixth operation is evaluated to have not been achieved may be determined as an OSR maximum limit value.

An eleventh example of the present disclosure relates to a learning system of an AI module based on entropy related to semantic segmentation of a LiDAR point cloud. In a case of the method according to the eleventh example of the present disclosure, including operations performed by the AI module, the operations including a first operation of learning a recognition function for objects classified into multiple classes from an arbitrary point cloud based on deep learning and the semantic segmentation using a first dataset, a second operation of actually applying the object recognition function to a point cloud input from the LiDAR, and determining entropy based on three parameters: the input point cloud, the class classifications, and a prediction rate of the AI module, a third operation of setting an edge case and an edge class of the recognition function based on the calculated entropy, and a fourth operation of generating a segmentation GT as a pseudo label for a second dataset including an object related to the edge class and then relearning a recognition function of the object.

The above description is merely illustrative of the technical idea of the present disclosure, and those skilled in the art to which the present disclosure pertains may make various modifications and variations without departing from the essential characteristics of the present disclosure.

Therefore, the examples disclosed in the present disclosure are not intended to limit the technical ideas of the present disclosure, but to explain them, and the scope of the technical ideas of the present disclosure is not limited by these examples. The protection range of the present disclosure should be interpreted by the claims below, and all technical ideas within the equivalent range should be interpreted as being included in the scope of the present disclosure.

What is claimed is:

1. An apparatus of a vehicle, the apparatus comprising:
a processor; and
a memory storing at least one instruction that, when executed by the processor communicating with the memory, is configured to cause the apparatus to:
train, using a first dataset, artificial intelligence (AI) model that recognizes an object based on data input from a sensor of the vehicle, wherein the AI model is trained to perform a recognition function for objects, wherein the objects are classified into multiple classes from an arbitrary point cloud based on deep learning and semantic segmentation of a sensor point cloud,
perform the recognition function on a point cloud input from the sensor,
based on the point cloud input, object classifications, and a prediction rate of the AI model, determine entropy of the AI model,
determine, based on the determined entropy, an edge case and an edge class associated with the recognition function,
generate a segmentation ground truth (GT) as a pseudo label for a second dataset, wherein the second data set comprises point cloud data associated with at least one object belonging to the edge class,
based on the second data set and the segmentation ground truth, retrain the AI model to perform the recognition function,
output, based on the retrained AI model, a signal indicating recognition of at least one object, and
control, based on the signal, autonomous driving of the vehicle.

2. The apparatus of claim 1, wherein the at least one instruction, when executed by the processor communicating with the memory, is configured to cause the apparatus to execute, based on the retrained AI model to perform the recognition function, an object recognition process for a point cloud, wherein the point cloud comprises the edge class.

3. The apparatus of claim 2, wherein the at least one instruction, when executed by the processor communicating with the memory, is configured to cause the apparatus to, based on an execution result of the object recognition process, measure a degree of performance improvement associated with the edge case and the edge class.

4. The apparatus of claim 1, wherein the edge case refers to a maximum prediction entropy frame in which the determined entropy is a highest among a plurality of frames, and wherein the plurality of frames comprise the point cloud input from the sensor.

5. The apparatus of claim 4, wherein the edge class refers to a class of an object that has a greatest influence on causing the determined entropy to be a highest within the maximum prediction entropy frame.

6. The apparatus of claim 3, wherein the at least one instruction, when executed by the processor communicating with the memory, is configured to cause the apparatus to retrain the AI model by:
retraining the AI model to recognize a misclassified object of the edge class, using a segmentation GT updated with a corrected label based on the semantic segmentation in an image area, wherein the image area comprises the misclassified object, and wherein the corrected label is based on the measured degree of performance improvement associated with the edge case and the edge class.

7. The apparatus of claim 3, wherein the at least one instruction, when executed by the processor communicating with the memory, is configured to cause the apparatus to measure the degree of performance improvement by measuring an improvement rate of intersection over union (IoU) or mean IoU (mIoU), wherein the IoU or the mIoU is determined from a predicted bounding box (P-Box) generated based on the AI model, a GT bounding box set for the edge class, and the retrained AI model.

8. The apparatus of claim 7, wherein the degree of performance improvement is determined in an evaluation condition in which the IoU for the edge class increases to a second threshold or higher, even though the mIoU decreases within a first threshold.

9. The apparatus of claim 7, wherein the at least one instruction, when executed by the processor communicating with the memory, is configured to cause the apparatus to, based on an over sampling rate (OSR) yielding a degree of performance improvement greater than a preset threshold, adjust a size of the second dataset.

10. The apparatus of claim 9, wherein an OSR threshold at which the degree of performance improvement begins to decrease is determined as an OSR maximum limit value.

11. A method performed by an apparatus of a vehicle, the method comprising:
training, using a first dataset, artificial intelligence (AI) model that recognizes an object based on data input from a sensor of the vehicle, wherein the AI model is trained to perform a recognition function for objects, wherein the objects are classified into multiple classes from an arbitrary point cloud based on deep learning and semantic segmentation of a sensor point cloud;
performing the recognition function on a point cloud input from the sensor;
based on the point cloud input, object classifications, and a prediction rate of the AI model, determining entropy of the AI model;
determining, based on the determined entropy, an edge case and an edge class associated with the recognition function;
generating a segmentation ground truth (GT) as a pseudo label for a second dataset, wherein the second data set comprises point cloud data associated with at least one object belonging to the edge class;
based on the second data set and the segmentation ground truth, retraining the AI model to perform the recognition function;
outputting, based on the retrained AI model, a signal indicating recognition of at least one object; and
controlling, based on the signal, autonomous driving of the vehicle.

12. The method of claim 11, further comprising:
executing, based on the retrained AI model to perform the recognition function, an object recognition process for a point cloud, wherein the point cloud comprises the edge class.

13. The method of claim 12, further comprising:
based on an execution result of the object recognition process, measuring a degree of performance improvement associated with the edge case and the edge class.

14. The method of claim 11, wherein the edge case refers to a maximum prediction entropy frame in which the determined entropy is a highest among a plurality of frames, and wherein the plurality of frames comprise the point cloud input from the sensor.

15. The method of claim 14, wherein the edge class refers to a class of an object that has a greatest influence on causing the determined entropy to be a highest within the maximum prediction entropy frame.

16. The method of claim 13, wherein the retraining of the AI model comprises
retraining the AI model to recognize a misclassified object of the edge class, using a segmentation GT updated with a corrected label based on the semantic segmentation in an image area, and wherein the image area comprises the misclassified object, and wherein the corrected label is based on the measured degree of performance improvement associated with the edge case and the edge class.

17. The method of claim 13, wherein the measuring of the degree of performance improvement comprises measuring an improvement rate of intersection over union (IoU) or mean IoU (mIoU), wherein the IoU or the mIoU is determined from a predicted bounding box (P-Box) generated based on the AI model, a GT bounding box set for the edge class, and the retrained AI model.

18. A vehicle comprising:
a sensor;
a driving control circuit configured to control autonomous driving of the vehicle;
a processor; and
a memory storing at least one instruction that, when executed by the processor communicating with the memory, is configured to cause the vehicle to:
obtain, from the sensor, a point cloud representing a surrounding environment of the vehicle,
perform, using a trained artificial intelligence (AI) model, a semantic segmentation on the point cloud to recognize at least one object and assign the at least one object to a class among a plurality of classes,
based on the point cloud, the class, and a prediction rate of the AI model, determine a prediction entropy value of the AI model,
identify a frame having a highest prediction entropy among a plurality of frames, wherein the plurality of frames comprises point clouds, and wherein the frame is defined as an edge case,
identify, among the plurality of classes, a class of an object contributing most to a highest entropy in the edge case, the class being defined as an edge class,
generate, based on the edge class, a second dataset, wherein the second dataset comprises a plurality of point clouds corresponding to the edge class,
generate, for the second dataset, segmentation ground truth data using pseudo-labeling or manual labeling,
based on the second dataset and the segmentation ground truth data, retrain the AI model,
output, based on the retrained AI model, a signal indicating recognition of the object, and
control, via the driving control circuit and based on the signal, autonomous driving of the vehicle.

19. The vehicle according to claim 18, wherein the at least one instruction, when executed by the processor communicating with the memory, is configured to cause the vehicle to determine a size of the second dataset based on an over sampling rate (OSR) that yields a highest improvement in recognition performance without exceeding an OSR maximum limit value that degrades accuracy of the AI model.

20. The vehicle according to claim 18, wherein the at least one instruction, when executed by the processor communicating with the memory, is configured to cause the vehicle to:
identify, from the second dataset, a subset of frames having highest prediction entropy values associated with the edge class, and
generate, using pseudo-labeling, segmentation ground truth data for the subset to selectively retrain the AI model for improved recognition of the edge class.
